(19) United States
(12) Patent Application Publication
(10) Pub. No.: US 2026/0278181 A1
(43) Pub. Date: Sep. 17, 2026

(54) ANTI-SKIMMING DEVICES

(71) Applicant: Publix Super Markets, Inc., Lakeland, FL (US)

(72) Inventors: Erik Gilbertsen, Lakeland, FL (US); Jonathan Pixley, Lakeland, FL (US); Dylan Ollila, Lakeland, FL (US)

(21) Appl. No.: 19/563,214

(22) Filed: Mar. 11, 2026

Related U.S. Application Data
(60) Provisional application No. 63/770,542, filed on Mar. 12, 2025.

(51) Int. Cl. G06F 21/86; B33Y 80/00

(52) U.S. Cl. CPC G06F 21/86; B33Y 80/00

(57) ABSTRACT

Embodiments provide a method, apparatus, and system for preventing the attachment of a skimming device to a point-of-sale PIN pad without evident and readily detectable tampering. A system is provided including: a POS (point-of-sale) terminal comprising a PIN (Personal Identification Number) pad; a POS terminal stand, wherein the POS terminal is pivotably attached to the POS terminal stand with a first fastener and a second fastener; a first member, the first member defining a first top extension and a first mid extension, wherein the first member is attached to the POS terminal with the first fastener, and the POS terminal is received between the first top extension and the first mid extension; a second member, the second member defining a second top extension and a second mid extension, wherein the second member is attached to the POS terminal with the second fastener, and the POS terminal is received between the second top extension and the second mid extension.

### CROSS-REFERENCE TO RELATED APPLICATIONS

This application claims priority to U.S. Provisional Application No. 63/770,542, filed on Mar. 12, 2025, the contents of which are hereby incorporated by reference in their entirety.

### TECHNOLOGICAL FIELD

An example embodiment of the present disclosure relates to a method, apparatus, and system for a tamper evident point-of-sale PIN pad guard, and more particularly, to a method, apparatus, and system for preventing the attachment of a skimming device to a point-of-sale PIN pad without evident and readily detectable tampering.

### BACKGROUND

Skimmers at point-of-sale (POS) devices are illicit tools used by criminals to steal credit, debit, or other payment card information during transactions. To prevent skimming, a need exists for anti-skimming devices. While electronic anti-skimming devices can be used to identify the presence of a skimming device attached to a POS terminal, these electronic devices can be bypassed or otherwise thwarted for continued undetected operation of the skimming device. Further, many electronic anti-skimming devices only operate to test a POS terminal, and require periodic testing with a tool which even when entirely reliable, leaves the POS terminal vulnerable between the periodic tests.

### BRIEF SUMMARY

Embodiments of the present disclosure provide a method, apparatus, and system for preventing the attachment of a skimming device to a point-of-sale PIN pad without evident and readily detectable tampering. A system is provided including: a POS (point-of-sale) terminal comprising a PIN (Personal Identification Number) pad; a POS terminal stand, wherein the POS terminal is pivotably attached to the POS terminal stand with a first fastener and a second fastener; a first member, the first member defining a first top extension and a first mid extension, wherein the first member is attached to the POS terminal with the first fastener, and the POS terminal is received between the first top extension and the first mid extension; a second member, the second member defining a second top extension and a second mid extension, wherein the second member is attached to the POS terminal with the second fastener, and the POS terminal is received between the second top extension and the second mid extension.

According to some embodiments the first member defines a first bottom extension, where the first member is attached to the POS terminal with the first fastener through the first bottom extension. According to certain embodiments the second member defines a second bottom extension, where the second member is attached to the POS terminal with the second fastener through the second bottom extension. According to some embodiments the first member and the second member are substantially mirror images of one another. According to certain embodiments a clearance between the POS terminal and the first top extension and the first mid extension is less than 3 millimeters.

The first member and the second member of some embodiments pivot with the POS terminal relative to the POS terminal stand at an axis defined through the first fastener and the second fastener. According to some embodiments the PIN pad is positioned within a top surface of the POS terminal, and wherein the first top extension and the second top extension extend over the top surface of the POS terminal on opposite sides of the PIN pad. According to certain embodiments a spacing between the first top extension and the top surface and a spacing between the second top extension and the top surface are less than 2 millimeters. According to some embodiments the first member and the second member are three-dimensionally printed. According to certain embodiments the first member and the second member are formed of a non-metallic material.

Embodiments provide an anti-skimmer POS (point-of-sale) terminal device including: a first member, the first member defining a first top extension and a first mid extension, wherein the first member is configured to attach to the POS terminal with a first fastener, and the first member is configured to receive the POS terminal between the first top extension and the first mid extension; a second member, the second member defining a second top extension and a second mid extension, wherein the second member is configured to attach to the POS terminal with a second fastener, and the second member is configured to receive the POS terminal between the second top extension and the second mid extension.

According to some embodiments the first member defines a first bottom extension, where the first member is attached to the POS terminal with the first fastener through the first bottom extension, where the second member defines a second bottom extension, where the second member is attached to the POS terminal with the second fastener through the second bottom extension. According to certain embodiments the first member and the second member are substantially mirror images of one another. According to certain embodiments a clearance between the POS terminal and the first top extension and the first mid extension and a clearance between the POS terminal and the second top extension and the second mid extension are each less than 3 millimeters.

The first member and the second member of some embodiments pivot with the POS terminal relative to a POS terminal stand at an axis defined through the first fastener and the second fastener. According to some embodiments the first top extension and the second top extension are configured to extend over a top surface of the POS terminal on opposite sides of a PIN (Personal Identification Number) pad of the POS terminal. According to certain embodiments a spacing between the first top extension and the top surface and a spacing between the second top extension and the top surface are less than 2 millimeters. According to some embodiments the first member and the second member are three-dimensionally printed. The first member and the second member of an example embodiment member are formed of a non-metallic material. The first member and the second member of some embodiments do not interfere with a chip reading slot of the POS terminal, a magnetic stripe reading channel of the POS terminal, or a contactless reader of the POS terminal.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 illustrates a Point of Sale (POS) terminal secured to a bracket according to an example embodiment of the present disclosure;

FIG. 2 illustrates a skimmer overlay for a POS terminal according to an example embodiment of the present disclosure;

FIG. 3 illustrates a top view of POS terminal with anti-skimming members attached according to an example embodiment of the present disclosure;

FIG. 4 illustrates a front view of a POS terminal with anti-skimming members attached according to an example embodiment of the present disclosure;

FIG. 5 illustrates a POS terminal bracket with anti-skimming members attached without the POS terminal according to an example embodiment of the present disclosure;

FIG. 6 illustrates a side view of a POS terminal bracket with anti-skimming members attached without the POS terminal according to an example embodiment of the present disclosure;

FIG. 7 illustrates a side view of anti-skimming members attached to a POS terminal bracket and a POS terminal according to an example embodiment of the present disclosure;

FIGS. 8A-8C illustrate several views of an anti-skimming member according to an example embodiment of the present disclosure;

FIGS. 9A-9C illustrate several views of an anti-skimming member according to another example embodiment of the present disclosure; and

FIGS. 10A-10C illustrate several views of an anti-skimming member according to another example embodiment of the present disclosure.

### DETAILED DESCRIPTION

Some embodiments of the present invention will now be described more fully hereinafter with reference to the accompanying drawings, in which some, but not all, embodiments of the invention are shown. Like reference numerals refer to like elements throughout. Indeed, various embodiments of the invention may be embodied in many different forms and should not be construed as limited to the embodiments set forth herein. Rather, these embodiments are provided so that this disclosure will satisfy applicable legal requirements.

As used herein, the term “or” is used in both the alternative and conjunctive sense, unless otherwise indicated. The term “along,” and similarly utilized terms, means near or on, but not necessarily requiring directly on an edge or other referenced location. The terms “approximately,” “generally,” and “substantially” refer to within manufacturing and/or engineering design tolerances for the corresponding materials and/or elements unless otherwise indicated. Thus, use of any such aforementioned terms, or similarly interchangeable terms, should not be taken to limit the spirit and scope of embodiments of the present disclosure. As used herein, references with directional modifiers, such as a “top”, “bottom”, “bottom surface”, “top surface”, or similar terms may be used to differentiate respective components and/or the relative positions of objects within the local reference frame being used and have no implications for the global positioning of various components relative to each other.

Modern payment systems for retail sales is becoming increasingly dependent on cashless payment methods. These cashless payment methods include credit cards and contactless payments. Credit card payments can be contactless through near field communication, though also sometimes still rely on reading of the magnetic stripe or use of the EMV (Europay®, Mastercard®, Visa®) chip of a card. Adversaries have endeavored to steal credit card information through various tactics over the years, and one technique that is currently employed is the use of credit card skimming devices. These skimming devices are designed to read a person's payment card information as they use the card during a transaction. The term payment card is used herein to include all types of payment cards, such as credit cards, debit cards, gift cards, check cards, or the like.

One of the most common forms of skimming devices is a skimming overlay, which attaches to a point-of-sale (POS) terminal that includes a payment card reader. The skimming overlay includes a payment card insertion slot that is positioned over a payment card insertion slot of the POS terminal such that transactions can continue to be performed normally. However, the payment card insertion slot of the skimming overlay includes a separate reader which reads the information from the payment card and provides that information to an adversary. Further, these skimming devices often include keypads which overlay the keypad of the POS terminal. If a user is using a “chip and PIN” (Personal Identification Number) payment method or a swipe with PIN payment method where they insert or swipe their payment card into the payment card slot and require a PIN to be entered for payment. The skimming device can thus read both the payment card information and detect the PIN entered that corresponds to the payment card. With this information, an adversary can generate payments that will appear to be from the original payment card and user, which can incur credit card charges, bank account withdrawals, or card balance reductions.

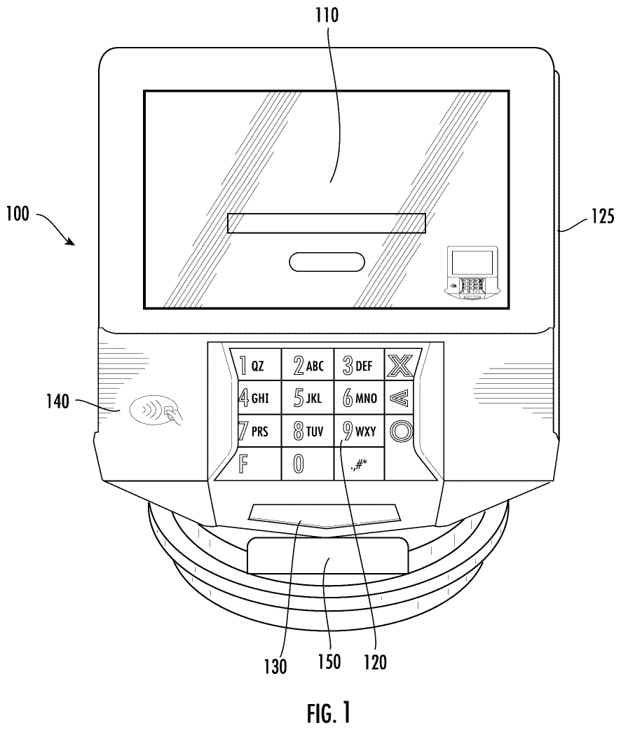

FIG. 1 illustrates an example embodiment of a POS terminal 100 including a display 110, a keypad 120, a magnetic stripe reader slot 125, a payment card reading slot 130, and a NFC (Near Field Communication) reader 140 which is used for contactless payments. The POS terminal 100 is mounted on a base 150 which enables the POS terminal to be adjusted to a position that is convenient for customer use.

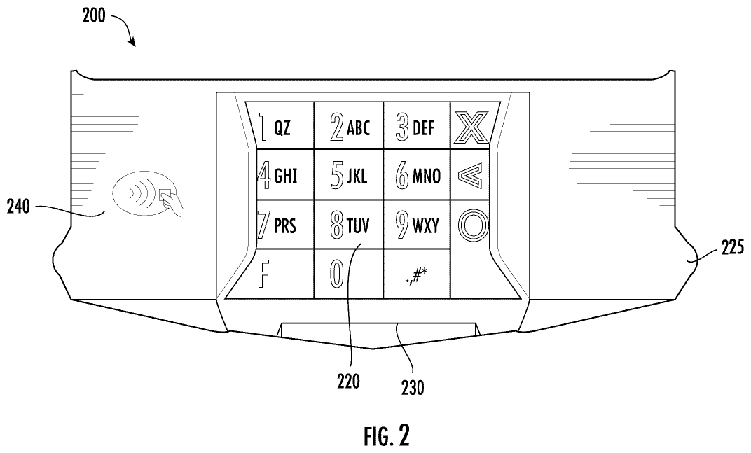

FIG. 2 illustrates a skimmer overlay 200. As shown, the skimmer overlay 200 mimics the lower half of the POS terminal 100 including a keypad 220, magnetic card reader 225, payment card slot 230, and NFC reader 240. The skimmer overlay 200 can be positioned over the lower half of a POS terminal as shown in FIG. 1 such that the keypad 220 of the skimmer overlay 200 is positioned over the keypad 120 of the POS terminal. Similarly, the payment card slot 230 of the skimmer overlay is directly over the payment card slot 130 of the POS terminal. The NFC reader 240 is positioned over the NFC reader 140 of the POS terminal. A well-designed skimmer overlay 200 can be virtually undetectable to the average consumer, such that it represents a significant vulnerability that adversaries may capitalize on.

Embodiments described herein protect against such skimmer overlays by providing a system that precludes attachment of a skimmer overlay while not disrupting the functionality of the POS terminal. Skimmer overlays grow a size of the POS terminal as they attach over the POS terminal. However, skimmer overlays may be very thin, such that they may only grow the size of a POS terminal by 2.5 millimeters in some circumstances. It is important for a POS terminal to be easy to access and easy to use for customer satisfaction. Thus, it is important for embodiments of the present system to be substantially transparent to a consumer in that the system should not interfere with the consumer's interaction with the POS terminal. Further, embodiments described herein are easy to install, which can increase a rate of adoption by retailers.

POS terminals such as the POS terminal 100 of FIG. 1 are designed to be resistant to tampering and theft. POS terminals that are tampered with, such as through the application of significant pressure suggesting a potential attempted removal-by-force, may trigger an anti-tamper response. The anti-tamper response of certain POS terminals includes a self-destruct sequence that effectively permanently disables the POS terminal rendering it useless to a potential thief. Embodiments of the present disclosure include a system that is further designed to avoid requiring significant manipulation of the POS terminal for installation, thus reducing a likelihood of triggering the anti-tamper response unintentionally.

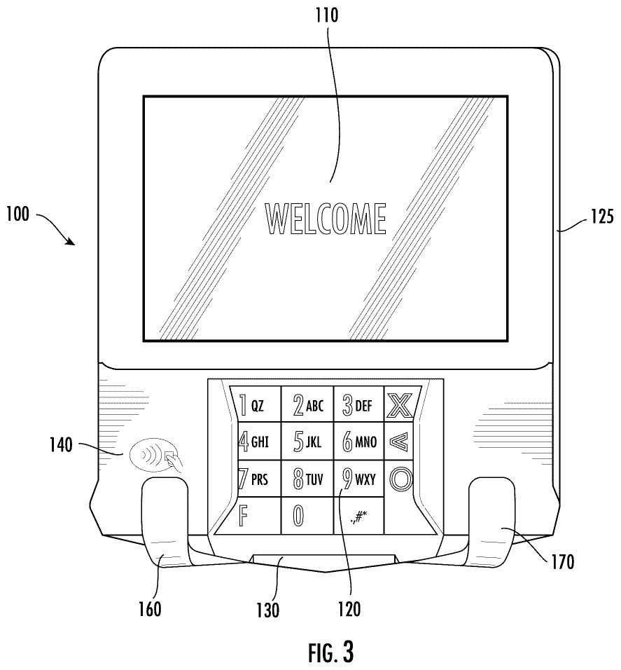

FIG. 3 illustrates a POS terminal 100 including an example embodiment of the anti-skimming system described herein. As shown, the POS terminal includes the display 110, the keypad 120, the magnetic stripe reader slot 125, the payment card slot 130, and the NFC reader 140. Also shown are a first member 160 and a second member 170. These members are minimally intrusive and do not block the magnetic stripe reader slot 125, the payment card slot 130 or the NFC reader 140, while enabling full access to the keypad 120. The first member 160 and the second member 170 are each different shapes or profiles. This is an intentional aspect of the system described herein as detailed further below.

The first member 160 and the second member 170 each extend from beneath the POS terminal 100, in front of the POS terminal where the payment card slot 130 is located, and over a top of the POS terminal covering over a portion of the top surface as shown. The functionality of this design will be described further below. However, it is notable that the first member 160 is close to the NFC reader 140. The first member 160 is preferably formed of a material that will not interfere with the NFC reader 140. Metals and metallic materials may disrupt the NFC reader communication since the NFC reader relies upon near-field communication protocols reading information from a card or device (e.g., a mobile phone) using antennas and specifically configured fields within which a device may be readable. Adding a metal element between the NFC reader 140 and a NFC card or device can compromise that communication and make the NFC reader less effective.

Embodiments described herein of the first member 160 and the second member 170 include brackets formed of materials such as plastics or resins, and the brackets themselves may be three-dimensionally printed, injection molded, cast, or otherwise formed to achieve the shapes and configurations described herein.

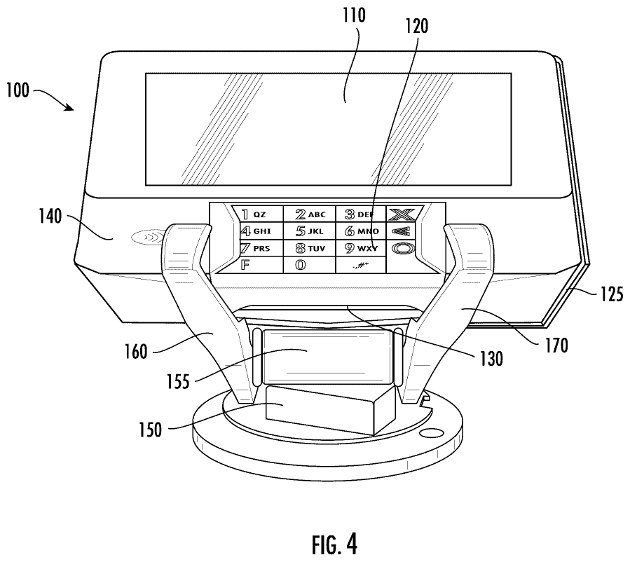

FIG. 4 illustrates a front view of the POS terminal 100 of FIG. 3 including the display 110, the keypad 120, the magnetic stripe reader slot 125, the payment card slot 130, and the NFC reader 140. The first member 160 and the second member 170 are each more clearly visible disposed on either side of the payment card reader slot 130. The base 150 is shown extending up to a pivot attachment 155, which serves as a location where the POS terminal 100 can pivot relative to the base 150 to reach a desirable position that is convenient to consumers. The first member 160 is attached at the pivot attachment and the second member 170 is attached to the opposite side of the pivot attachment.

As is evident through the illustration of FIG. 4, the skimmer overlay 200 of FIG. 2 cannot be attached to the POS terminal 100 as the first member 160 and the second member 170 preclude attachment of such a device proximate the payment card slot 130 and the keypad 120. The first member 160 and the second member 170 also taper toward one another from the keypad 120 past the payment card slot 130. This tapering together provides a challenge to an adversary attempting to design a skimmer overlay that can fit between the first member 160 and the second member 170 as it does not afford an adversary a clear approach to attach a skimmer overlay in the uniquely shaped area left available.

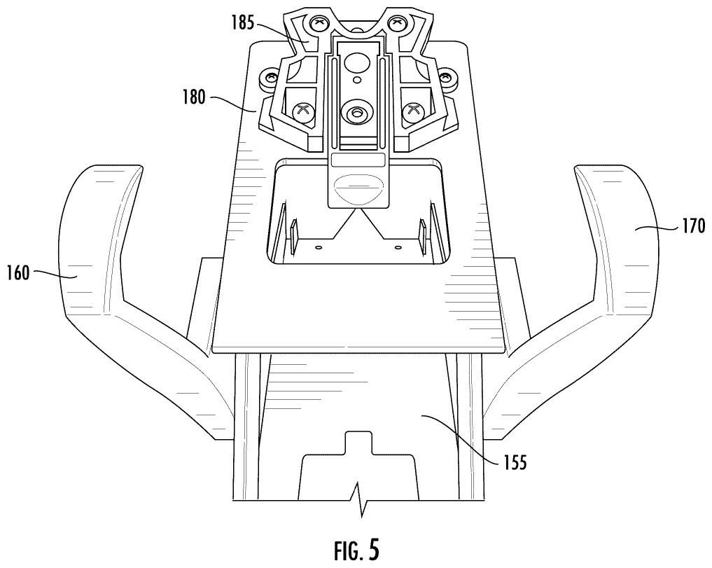

FIG. 5 illustrates the disclosed first member 160 and second member 170 attached to the pivot attachment 155 with the POS terminal removed. As shown, a bracket 180 that pivots from the pivot attachment 155 includes an interface 185 onto which the POS terminal is received and secured for operation in retail environment. The first member 160 and the second member 170 are rigidly mounted to the bracket 180 and the bracket pivots with the POS terminal together with the first member 160 and second member 170 at the pivot attachment 155.

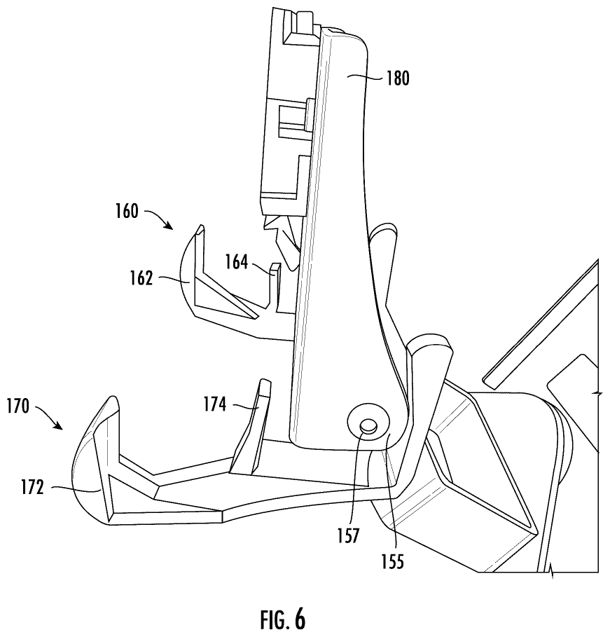

FIG. 6 illustrates a side-view of the first member 160 and second member 170 attached to the pivot attachment 155 and bracket 180 as shown in FIG. 5, with the POS terminal removed. Visible in the side-view of FIG. 6 are the elements of the first member 160 and second member 170 that engage the POS terminal when the POS terminal is attached to the bracket 180. The bracket 180 is attached to pivot attachment 155 with a fastener 157. The fastener 157 shown in the illustrated view attaches the second member 170 to the pivot attachment 155 such that the second member 170 pivots with the bracket 180 about an axis along with the fastener 157 extends. The first member 160 is attached to the pivot attachment 155 by another fastener in substantially a mirror image of the view shown.

The first member 160 includes a first top extension 162 and a first mid extension 164. The second member 170 also includes a second top extension 172 and a second mid extension 174. When the POS terminal is attached to the bracket 180, the first top extension 162 and second top extension 172 extend over a top surface of the POS terminal, while the first mid extension 164 and second mid extension 174 extend under a bottom surface of the POS terminal. A gap between the first top extension 162 and first mid extension 164 is sized to receive the POS terminal with a minimal clearance. In an example embodiment, the clearance is less than 3 millimeters. The second member 170 is similarly configured with the spacing between the second top extension 172 and the second mid extension 174 being substantially the same as for the first member 160. The gap between the first top extension 162 and the first mid extension 164 along with the gap between the second top extension 172 and the second mid extension 174 is of critical importance. The gap is designed to snugly fit over the POS terminal with little clearance. This close tolerance is necessary since skimmer overlays may only grow a thickness of a POS terminal by 2.5 millimeters in some cases, such that the gap is designed to not allow such a thickness increase. As the POS terminals are of a consistent and reliable thickness, embodiments described herein are designed to fit very tightly with the POS terminal. The clearance or difference between the width of the gap and the thickness of the POS terminal is generally less than 3 millimeters, and in some cases is as little as 0.25 millimeters.

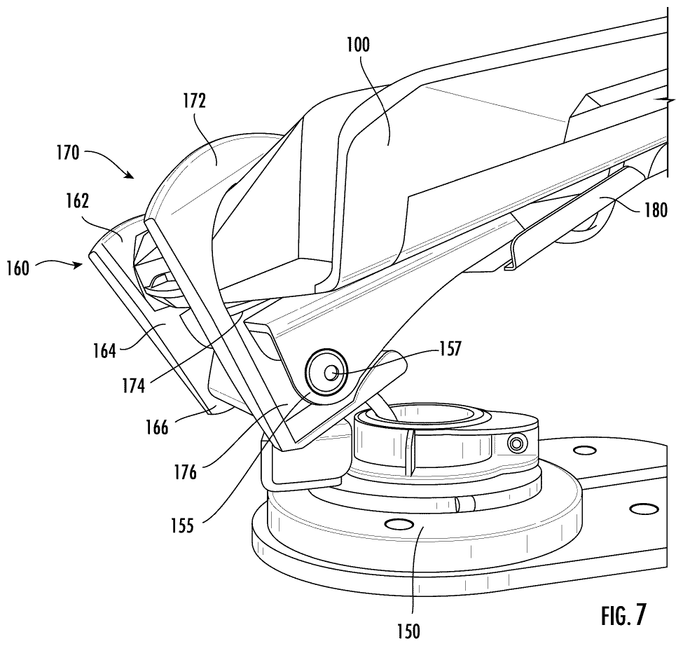

FIG. 7 illustrates a side-view of a POS terminal 100 as secured to bracket 180, which is in turn attached to the base 150 via pivot attachment 155 by fastener 157. The first member 160 and second member 170 are shown, with the second member 170 being most prominent in the foreground. As shown, the POS terminal 100 is secure to the bracket 180 and received between the second top extension 172 and the second mid extension 174. Also shown in FIG. 7 is the attachment between the second member 170 and the pivot attachment 155. As shown, the second member includes a bottom extension 176 which is attached to the pivot attachment 155 via fastener 157. The use of the fastener 157 to both attach the bracket 180 to the base 150 and the second member 170 to the bracket 180 reduces complexity and renders the second member 170 easily installed or replaced. The fastener 157 may be a tamper-resistant fastener to dissuade an adversary from tampering with the fastener and the anti-skimming device described herein.

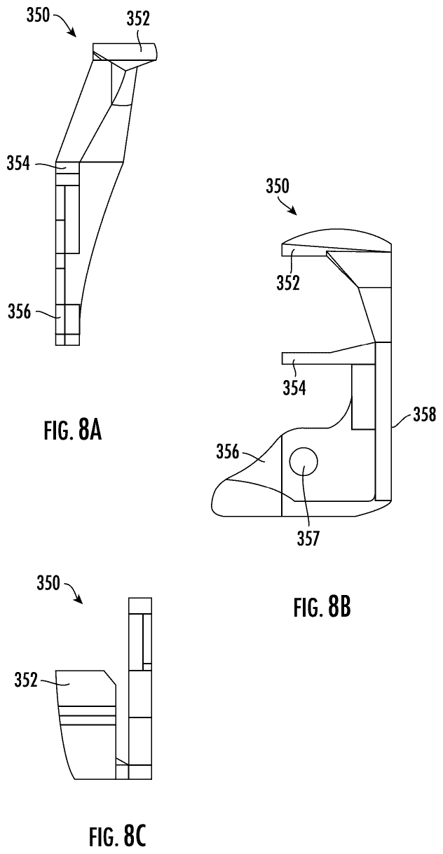

FIGS. 8A-8C illustrate several views of an anti-skimming member 350 as described herein. The depicted anti-skimming member 350 can be a first member or second member as described above with respect to FIGS. 3-7. Generally, the anti-skimming member 350 may be unique to a specific side of the POS terminal and bracket thereof, such that the first member 160 may be substantially a mirror image of the second member 170. As such, the anti-skimming member 350 of FIGS. 8A-8C is illustrated as one of these members, while the mirror image of the anti-skimming member 350 of FIGS. 8A-8C would be the complementary member in attaching to a POS terminal for the anti-skimming system described herein.

The anti-skimming member 350 of FIGS. 8A-8C is shown in FIG. 8A depicted in a front view, FIG. 8B is a side view, and FIG. 8C is a top view. The top view of FIG. 8C illustrates how the anti-skimming member 350 would be seen from above the POS terminal from the perspective of a consumer viewing the display. The side view of FIG. 8B illustrates the top extension 352, the mid extension 354, and the bottom extension 356. The bottom extension 356 includes fastener aperture 357 configured to receive the fastener 157 in attaching the anti-skimming member 350 to the bracket 180 described above. The anti-skimming member 350 further includes a spine 358 from which each of the top extension 352, mid extension 354, and bottom extension 356 extend.

The anti-skimming members described herein are evident when secured to a bracket and a POS terminal while not interfering with operation of the POS terminal. The visibility of these anti-skimming members is beneficial for two primary reasons. The visibility provides peace of mind for consumers in being able to see a system that does not permit a skimmer overlay to be attached to the POS terminal. The visibility also provides a deterrent to adversaries that are aiming to install skimmer overlays to a POS terminal. However, the visibility provides an additional advantage as detailed herein.

The anti-skimming members as described herein, are designed to break or split in response to excessive force applied to the anti-skimming member, such as by an adversary attempting to bypass the anti-skimming functionality of the devices. POS terminals are somewhat vulnerable devices. As described above, application of significant force to the POS terminal can result in the POS terminal self-destruct to render the POS terminal of no use. It is undesirable for a POS terminal to self-destruct as they are costly devices and taking a POS terminal out-of-service may diminish retail checkout capacity and increase consumer wait times in check out lines. If an adversary is attempting to bypass the anti-skimming members described herein through use of force, it would be undesirable for the anti-skimming members to be rigid, translating all force applied to the anti-skimming members to the POS terminal. Thus, anti-skimming members described herein are designed to break away in response to significant force applied to the anti-skimming members. The anti-skimming members are not delicate; however, application of force that is clearly an adversarial attempt to remove the anti-skimming devices would be sufficient to break away a portion of the anti-skimming members.

Each anti-skimming member is configured with a designed point-of-failure such that in response to application of sufficient force to the anti-skimming member, the anti-skimming member will break. This point may be, for example, at a location along the spine 358 of the anti-skimming member 350. The designed point-of-failure is configured to break under less force than would be required to damage the POS terminal, and significant force is thus not transmitted via the anti-skimming members into the bracket or the POS terminal.

The visibility of the anti-skimming members described herein provides further advantage with regard to tampering. If an adversary is successful in breaking one or both of the anti-skimming members, it becomes apparent to a consumer or employee that the anti-skimming members have been compromised, and replacement of the anti-skimming member(s) is necessary to restore the POS terminal to use after evaluating the POS terminal for any skimming overlays. Due to the single-fastener installation of the anti-skimming members described herein, the replacement of the anti-skimming members is a quick task that returns the POS terminal to operation in short order. Further, the POS terminal does not need to be removed or tampered within in replacing the anti-skimming members described herein.

Adversaries often work quickly to overcome obstacles presented that guard against adversarial activities. With the anti-skimming members described herein, an adversary may endeavor to design a POS terminal skimming overlay that accommodates the anti-skimming members. This may be feasible if the anti-skimming members were uniform and consistent across all POS terminals in a store or within a chain of stores. However, embodiments of the anti-skimming members described herein are designed with multiple configurations such that the anti-skimming members may vary from POS terminal to POS terminal. Further, as there are left and right anti-skimming brackets, the designs may be mis-matched resulting in many potential combinations of anti-skimming members, rendering a design around challenging.

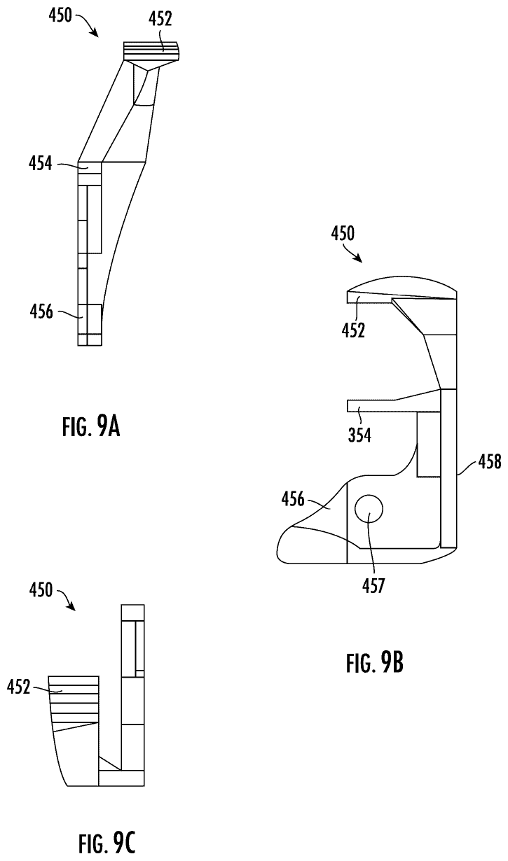

FIGS. 9A-9C illustrate another example embodiment of an anti-skimming member 450 shown in a front view in FIG. 9A, side view in FIG. 9B, and top view in FIG. 9C. As shown, the anti-skimming member 450 differs in some aspects to the anti-skimming member of FIGS. 8A-8C, with the key functionality remaining the same among the top extension 452, mid extension 454, and bottom extension 456, each extending from spine 458. As shown, the shape and size of the top extension 452 differs from that of the top extension 352 of the anti-skimming member of FIGS. 8A-8C. Further, a width of the top extension 452 differs thereby providing physical distinctions. If an adversary attempts to design a skimmer overlay that avoids the anti-skimming member of FIGS. 8A-8C, it would require precision to remain undetectable relative to the POS terminal. Introducing even the relatively minor changes between the anti-skimming member 350 of FIGS. 8A-8C and the anti-skimming member of FIGS. 9A-9C significantly increases the difficulty with which an adversary would have to develop an undetectable skimming overlay.

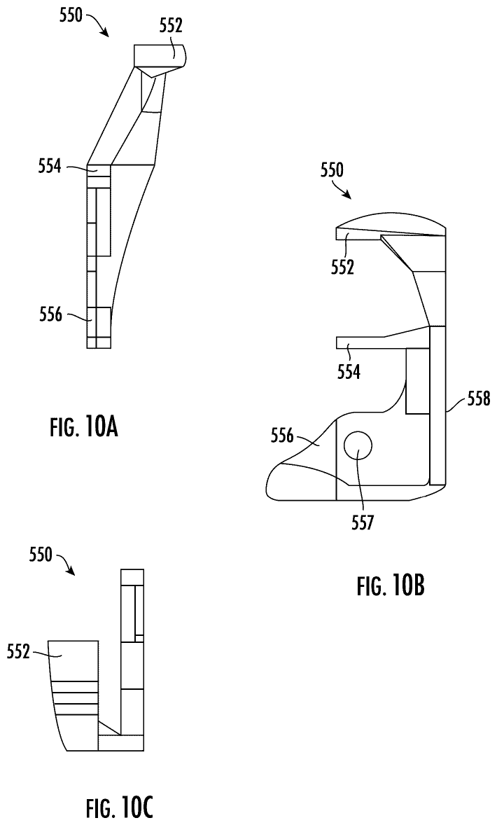

FIGS. 10A-10C illustrate still another embodiment of an anti-skimming member 550. The illustrated embodiment of FIGS. 10A-10C depicts a front view in FIG. 10A, side view in FIG. 10B, and top view in FIG. 10C. As shown, the bottom extension 552 is again distinct from that of the bottom extensions 352, 452 of the anti-skimming devices of FIGS. 8A-8C and 9A-9C. The distinct bottom extension 552 and geometry thereof provides additional complexity for an adversary in addressing the different anti-skimming members of the different designs. The anti-skimming member 550 of FIGS. 10A-10C retains the same functionality as the previously described anti-skimming members including the top extension 552, mid extension 554, and bottom extension 556, each extending from spine 558.

Various embodiments of anti-skimming devices are disclosed. In one embodiment, because each POS terminal could have any combination of a left and right versions, the various designs are configured such that a skimmer could not easily be molded to fit over or around the brackets.

In one embodiment, to install an anti-skimming device, one can remove the POS terminal from an existing bracket and attach the anti-skimming device. In another embodiment, an anti-skimming device can attach around the base without requiring removal of the POS terminal.

Many modifications and other embodiments will come to mind to one skilled in the art to which this disclosure pertains having the benefit of the teachings presented in the foregoing descriptions, the associated drawings, and the included appendices. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system comprising:
a POS (point-of-sale) terminal comprising a PIN (Personal Identification Number) pad;
a POS terminal stand, wherein the POS terminal is pivotably attached to the POS terminal stand with a first fastener and a second fastener;
a first member, the first member defining a first top extension and a first mid extension, wherein the first member is attached to the POS terminal with the first fastener, and the POS terminal is received between the first top extension and the first mid extension;
a second member, the second member defining a second top extension and a second mid extension, wherein the second member is attached to the POS terminal with the second fastener, and the POS terminal is received between the second top extension and the second mid extension.

2. The system of claim 1, wherein the first member defines a first bottom extension, wherein the first member is attached to the POS terminal with the first fastener through the first bottom extension.

3. The system of claim 2, wherein the second member defines a second bottom extension, wherein the second member is attached to the POS terminal with the second fastener through the second bottom extension.

4. The system of claim 3, wherein the first member and the second member are substantially mirror images of one another.

5. The system of claim 1, wherein a clearance between the POS terminal and the first top extension and the first mid extension and a clearance between the POS terminal and the second top extension and the second mid extension are each less than 3 millimeters.

6. The system of claim 1, wherein the first member and the second member pivot with the POS terminal relative to the POS terminal stand at an axis defined through the first fastener and the second fastener.

7. The system of claim 1, wherein the PIN pad is positioned within a top surface of the POS terminal, and wherein the first top extension and the second top extension extend over the top surface of the POS terminal on opposite sides of the PIN pad.

8. The system of claim 7, wherein a spacing between the first top extension and the top surface and a spacing between the second top extension and the top surface are less than 2 millimeters.

9. The system of claim 1, wherein the first member and the second member are three-dimensionally printed.

10. The system of claim 1, wherein the first member and the second member are formed of a non-metallic material.

11. An anti-skimmer POS (point-of-sale) terminal device comprising:
a first member, the first member defining a first top extension and a first mid extension, wherein the first member is configured to attach to the POS terminal with a first fastener, and the first member is configured to receive the POS terminal between the first top extension and the first mid extension;
a second member, the second member defining a second top extension and a second mid extension, wherein the second member is configured to attach to the POS terminal with a second fastener, and the second member is configured to receive the POS terminal between the second top extension and the second mid extension.

12. The device of claim 11, wherein the first member defines a first bottom extension, wherein the first member is attached to the POS terminal with the first fastener through the first bottom extension, wherein the second member defines a second bottom extension, wherein the second member is attached to the POS terminal with the second fastener through the second bottom extension.

13. The device of claim 12, wherein the first member and the second member are substantially mirror images of one another.

14. The device of claim 11, wherein a clearance between the POS terminal and the first top extension and the first mid extension is less than 3 millimeters.

15. The device of claim 11, wherein the first member and the second member pivot with the POS terminal relative to a POS terminal stand at an axis defined through the first fastener and the second fastener.

16. The device of claim 11, wherein the first top extension and the second top extension are configured to extend over a top surface of the POS terminal on opposite sides of a PIN (Personal Identification Number) pad of the POS terminal.

17. The device of claim 16, wherein a spacing between the first top extension and the top surface and a spacing between the second top extension and the top surface are less than 2 millimeters.

18. The device of claim 11, wherein the first member and the second member are three-dimensionally printed.

19. The device of claim 11, wherein the first member and the second member are formed of a non-metallic material.

20. The device of claim 11, wherein the first member and the second member do not interfere with a chip reading slot of the POS terminal, a magnetic stripe reading channel of the POS terminal, or a contactless reader of the POS terminal.
